(19) United States
(12) Patent Application Publication
(10) Pub. No.: US 2019/0102149 A1
(43) Pub. Date: Apr. 4, 2019

(54) METHOD FOR PROVIDING AN INTEGRATED PROCESS FOR CONTROL UNIT DEVELOPMENT AND A SIMULATION DEVICE FOR CONTROL UNIT DEVELOPMENT

(71) Applicant: dSPACE digital signal processing and control engineering GmbH, Paderborn (DE)

(72) Inventors: Irina ZACHARIAS, Paderborn (DE); Rafael GILLES, Paderborn (DE)

(73) Assignee: dSPACE digital signal processing and control engin eering GmbH, Paderborn (DE)

(21) Appl. No.: 16/146,018

(22) Filed: Sep. 28, 2018

(30) Foreign Application Priority Data
Sep. 29, 2017 (DE) 10 2017 122 726.1
Apr. 26, 2018 (DE) 10 2018 110 018.3

(51) Int. Cl. G06F 8/35; G06F 17/50; G06F 8/41; G06F 9/44

(52) U.S. Cl. CPC G06F 8/35; G06F 9/44; G06F 8/433; G06F 17/5009

(57) ABSTRACT

A method for providing an integrated control unit development process based on a plurality of simulation models, having at least one first simulation model and a second simulation model, wherein the integrated process simulates a control unit or an environment of a control unit and is executable on a simulation device. The method includes the steps: isolating externally visible first communication parameters of the first simulation model and isolating externally visible second communication parameters of the second simulation model; comparing the first communication parameters and the second communication parameters and identifying identically named communication parameters; and modifying the identically named communication parameters at least for one of the first simulation models and the second simulation models such that the integrated process is executable on a single processor core.

This nonprovisional application claims priority under 35 U.S.C. § 119(a) to German Patent Application No. 10 2017 122 726.1, which was filed in Germany on Sep. 29, 2017, and German Patent Application No. 10 2018 110 018.3, which was filed in Germany on Apr. 26, 2018, and which are both herein incorporated by reference.

### BACKGROUND OF THE INVENTION

### Field of the Invention

The present invention relates to the development of control units as they are used, e.g., in the automotive industry or in the aviation industry for controlling technical systems such as, e.g., engines or brakes. In particular, the present invention relates to simulation devices used in the control unit development process and to methods for providing processes executable on simulation devices.

### Description of the Background Art

The development of control units has become a highly complex process. New control units or new control functions should therefore be tested as early in the development process as possible in order to check the general functionality and to set the direction for further development. It is important toward the end of the development process to test the already far developed control unit as comprehensively as possible in order to make necessary modifications based on the test results before the control unit is placed in use or goes into mass production, so that it functions as desired under all possible conditions in later operation.

So-called hardware-in-the-loop simulators (HIL simulators/HIL simulation devices) are used at a very late stage of the development process. Such HIL simulators contain a model of the technical system to be controlled, the model being present in the software. In addition, the HIL simulator can include further models of technical systems located in the environment of the control unit and the technical system to be controlled and interacting with the control unit and/or the technical system to be controlled. The HIL simulator further contains an input/output interface to which the control unit, which has already undergone extensive development and is already physically present in the hardware, also referred to as a hardware implementation of the control unit, can be connected.

The functionality of the control unit can now be tested in various simulation runs, wherein it is possible to observe the reactions of the model of the technical system to be controlled to the signals of the control unit and the reactions of the control unit to events predefined by the model of the technical system to be controlled. Optionally, the behavior of further technical systems from the environment of the control unit and of the technical system to be controlled can also be observed. In this process, it is possible to simulate both normal operation and faults in the technical system to be controlled as well as faults in the control unit, as well as faults in the communication between the control unit and the system to be controlled, such as, e.g., a cable bridge, as well as faults in the power supply, such as, e.g., short circuits. The HIL simulator is an example of a simulation device set up for control unit development.

In contrast, the so-called rapid control prototyping (RCP) is a development step that takes place more toward the start of the development process. In RCP, the simulation device is used in the role of the control unit. The simulation device contains a model of the control unit to be tested. Because of the early stage of development, the model of the control unit to be tested is still fairly rudimentary in comparison with the later final control unit. Nor is any hardware implementation of the control unit normally in existence yet; instead, the model, present in the simulation device, of the control unit to be tested is a software model. Further, the simulation device can contain other models, such as, e.g., models of technical systems with which the control unit is later to interact in addition to the system to be controlled. Thus, a broad environment of the control unit can be reproduced in the simulation device. The simulation device can be connected via an input/output interface to the technical system to be controlled itself or to the control unit that exists to date for the technical system to be controlled. In the first case, there is a direct connection between the control unit to be tested, in the form of a software model, and the physically present technical system to be controlled. In the second case, the control unit that exists to date is the technical system to be controlled by the RCP simulation device. This control of the control unit that exists to date results in a modification of the control method of the control unit that exists to date, making it possible to test a new control functionality by means of the externally connected RCP simulation device. This arrangement is also referred to as bypassing.

While a simulation is being performed, the described models are executed as executable processes both in an HIL simulation device and in an RCP simulation device, wherein due to the complexity of the simulations, a multitude of processors or processor cores are generally used. The apportioning of the models to processors or processor cores is not always satisfactory in this case.

### SUMMARY OF THE INVENTION

It is therefore an object of the present invention to provide a method for providing processes executable on simulation devices as well as simulation devices that enable greater flexibility in creating and performing simulations.

Exemplary embodiments of the invention comprise a method for providing an integrated control unit development process based on a plurality of simulation models, comprising at least one first simulation model and a second simulation model, wherein the integrated process simulates a control unit or an environment of a control unit, in particular a technical system to be controlled, or a combination of a control unit and an environment of a control unit, in particular a combination of a control unit and a technical system to be controlled, and is executable on a simulation device, the method comprising the steps: isolating externally visible first communication parameters of the first simulation model and isolating externally visible second communication parameters of the second simulation model; comparing the first communication parameters and the second communication parameters and identifying identically named communication parameters; and modifying the identically named communication parameters at least for one of the first simulation models and the second simulation models such that the integrated process is executable on a single processor core.

Exemplary embodiments of the invention enable a flexible allocation of simulation models to hardware resources of simulation devices and thereby open up the possibility of conserving hardware resources and/or coupling simulation models in a manner advantageous for the execution. Compared to previous approaches in which a process has been created for each model and precisely such a process has been carried out on each processor core, exemplary embodiments of the invention enable the creation of an integrated process that couples two or more models for execution on a simulation device and makes them executable on one processor core. By modifying identically named communication parameters, it is ensured that the two submodels that are present in executable form in the integrated process can communicate uniquely with each other and with other models executed on other processor cores, as well as with entities, if any, present outside the simulation device. Non-unique calls of variables and/or functions of the two simulation models can be avoided. A unique calling up and response of the individual simulation models is ensured with the possibly modified communication parameters at least via the information about the processor core on which the integrated process is executed. Further, by integrating multiple simulation models into one executable process, optimizations for execution can be achieved, for example, in terms of manageability, better utilization of computational power, and communication speed between the models, as will be described in detail below.

The term ‘process’ can designate a process in the computer-technical sense, i.e., a process executable on a processor, also referred to as an application process. Accordingly, the term ‘process’, provided on the basis of a plurality of simulation models, refers to a process that is executable on a processor and contains the functionality of the plurality of simulation models together in an executable manner. The simulation models can thus be executed together in the same process on the same processor core and communicate with each other within this one process. The data exchange between the two simulation models can be restricted to a single process at the process level.

The integrated process can be executed on a simulation device. The simulation device can be an HIL simulator or an RCP simulation device. The integrated process can simulate a control unit or an environment of a control unit or a combination of a control unit and an environment of a control unit. The environment of a control unit can be a technical system to be controlled or a system interacting with the control unit and/or the technical system to be controlled or a combination of a technical system to be controlled and a system interacting with the control unit and/or the technical system to be controlled. In other words, the environment of a control unit can be the technical system to be controlled by the control unit or any other entity interacting with the combination of the control unit and technical system to be controlled.

The integrated process is provided based on at least one first simulation model and a second simulation model. Each of the simulation models can be a model of a control unit or a model of a part of a control unit or a model of an environment of a control unit or part of an environment of a control unit. Again, the environment of the control unit can be in particular a technical system to be controlled. In the case that the simulation device is an HIL simulator, for example, the first simulation model can be a model of a first part of the system to be controlled and the second simulation model can be a model of a second part of the system to be controlled. For example, it is also possible in the HIL case that the first simulation model is a model of the technical system to be controlled by the control unit connected to the HIL simulator, and that the second simulation model is a model of an environment of the combination of the control unit and of the technical system to be controlled, wherein this environment interacts with said combination. In the case that the simulation device is an RCP simulation device, for example, the first simulation model can be a model of a first part of the control unit to be tested and the second simulation model can be a model of a second part of the control unit to be tested. For example, it is also possible in the RCP case that the first simulation model is a model of the control unit to be tested and that the second simulation model is a model of an environment of the combination of the control unit to be tested and the technical system to be controlled. The first and second simulation model can be any model or submodel of the control unit, the technical system to be controlled, and the periphery of the control unit and the technical system to be controlled, which are relevant to the desired simulation.

The plurality of simulation models can comprise exactly the first simulation model and the second simulation model. It is also possible for the plurality of simulation models to have more than two simulation models, in particular 3, 4, 5, 6, 7, 8, or even more simulation models. The more than two simulation models can each be submodels or complete models of all the entities mentioned above. It is also possible, for example, that a plurality of simulation models for different entities are present in the environment of a control unit or a technical system to be controlled in the more than two simulation models mentioned.

The method identifies identically named communication parameters in the externally visible communication parameters of the first simulation model and the second simulation model. The term ‘externally visible communication parameters’ designates communication parameters that are addressed from outside the respective simulation model and/or from outside the combination of the simulation models. In other words, the externally visible communication parameters are the communication parameters that are used for communication between the simulation models that are integrated into the integrated process, as well as the communication parameters that are used to interact with other entities from outside of the simulation models mentioned. The term ‘communication parameter’ is herein a designation of a programming-technical variable, such as, e.g., an interface function, or a variable via which access to the relevant simulation model can occur.

The method modifies identically named communication parameters at least for one of the first simulation models and the second simulation models. In particular, the method can modify identically named communication parameters for both the first simulation model and the second simulation model.

The integrated process is executable on a single processor core. In the case that the processor used to execute the integrated process has only one processor core, it is the same as saying that the integrated process is executable on a single processor.

The first communication parameters and the second communication parameters can comprise variable names and/or calls for interface functions. Thus, depending on the needs of the specific implementation, one or more variables and/or one or more interface functions of the first simulation model and/or the second simulation model can be addressed, read, written, and/or called up. The communication between the plurality of simulation models that are integrated into the integrated process as well as the communication to the outside of the integrated process can be designed in a comprehensive manner via interface functions and variables.

Modifying the identically named communication parameters can comprise applying a wrapper function to the identically named communication parameters. Applying a wrapper function to identically named communication parameters provides an elegant and less complex way of ensuring unique names, on the one hand, and thus a unique response of the communication parameters and, on the other hand, of slightly modifying the structure present in the respective simulation models and thus keeping the intervention in the structure of the respective simulation models low. The risk of negatively affecting the individual simulation models by changing the identically named communication parameters can thus be kept low.

The method can further comprise the steps: compiling the first simulation model into a first object file; compiling the second simulation model into a second object file; and merging the first object file and the second object file into a common object file. In particular, the steps of compiling the first simulation model into a first object file and of compiling the second simulation model into a second object file and possibly also merging into a common object file can be performed prior to the step of identifying identically named communication parameters. At the object file level, identically named communication parameters can be conveniently identified within a given frame. In addition, the communication parameters that are externally visible are readily identifiable at the object file level. Furthermore, the object file level represents an easily manageable intermediate step for the simulation models, especially if the simulation models originate from different modeling environments, as will be described below.

The first simulation model and the second simulation model can originate from different modeling environments. For example, for the case that the simulation device is an HIL simulator, it is possible that the first simulation model is a model of a system to be controlled that is provided for execution on an HIL simulator, and that the second simulation model is a model of a further technical system interacting with the system to be controlled, which is used for execution in a purely computer-aided simulation at an early stage of control unit development. For example, for the test of an engine control unit, an HIL simulator can be provided in which the first simulation model described herein is a simulation model of an engine for an HIL simulator, and in which the second simulation model described herein is a simulation model of a transmission which interacts with the engine and was originally provided for a purely computerized tool such as, e.g., Simulink®. In this case, integrating a simulation model originally not provided for the HIL simulator into a process executable on the HIL simulator is enabled, wherein care is taken that simulation models not originally provided for the same simulation device are integrated into a single executable process. High, simultaneous flexibility in the combination of simulation models from different modeling environments and in the allocation of hardware resources to the combined simulation models can be achieved in this way. In this context, compiling the simulation models into object files is particularly advantageous because the object file level creates a common standard for the simulation models from different modeling environments. It is emphasized, however, that other standardized intermediate levels can also be used toward the integrated process when compiling the simulation models. In this context, the first simulation model can come from a modeling environment, for example, that is specifically suited for the creation of engine simulations (e.g., Dymola®) and the second simulation model can come from a modeling environment that is especially suitable for the creation of transmission models (e.g., SimulationX®). For example, the integration into a process can also take place in that a so-called Functional Mock-up Unit (FMU) is created from the simulation models. The FMUs could interact via the so-called functional mock-up interface for co-simulation or model exchange and be integrated into an executable process.

The integrated process can be provided in the form of a single executable file. In this way, the integrated process can be made to run directly and immediately on a processor core. The integrated process as well is easily movable in this way between different processor cores of a complex simulation device, e.g., between different processor cores of an HIL simulator.

The method can further comprise the following step: setting a calculation order of the plurality of simulation models in the integrated process based on the data transfer structure between the simulation models. The term ‘data transfer structure’ is an umbrella term for the data transfer links between the simulation models. In particular, the data transfer structure can include a plurality or multitude of data transfer links. Each data transfer link has at least one outputting simulation model and at least one receiving simulation model. By setting the calculation order of the plurality of simulation models based on the data transfer structure, it is possible to optimize the integrated process in terms of resource requirements and/or quality of the simulation results. The quality can be optimized, for example, by calculating as many results as possible for the individual simulation models in an advantageous order. The resource requirements can be optimized, for example, by bundling and processing data transfers in an advantageous manner.

The calculation order of the plurality of simulation models can be set based on at least one of the following factors: configuration of the particular data transfer link as a blocking data transfer link, in which the receiving simulation model is calculated if there are new input data, or as a non-blocking data transfer link, in which the receiving simulation model is calculated independently of the presence of new input data; and the presence of unilateral data transfer, bilateral data transfer, or no data dependency between respective pairs of simulation models or respective pairs of groups of simulation models. In this way, based on the receiving mode of the particular simulation models and/or based on the communication direction(s) between the particular simulation models, a calculation order can be set that is beneficial for optimized resource utilization and/or simulation quality. The term ‘bilateral data transfer’ used above also includes indirect bilateral data transfer, i.e., data transfer in a closed loop over more than two simulation models.

The method further can comprise the following step: combining simulation models into higher-level sorting units by forming subsets of simulation models communicating over blocking data transfer links. By combining simulation models based on blocking data transfer links, such sorting units are formed whose simulation models only have to be executed conditionally within the sorting units, namely, when there are new input data. In addition, new input data can be made available bundled. An execution of the simulation models optimized overall with regard to resource utilization and/or simulation quality can be achieved.

The method can comprise the following step: setting the calculation order of the higher-level sorting units based on the number of data transfer links that provide input data to the respective higher-level sorting units. In particular, those higher-level sorting units can be calculated first that have a smaller number of data transfer links than the others. It can be achieved in this way that as many recalculated input data as possible are already available for those higher-level sorting units that have relatively many input data. Thus, a high simulation quality in particular can be achieved.

Setting the calculation order of the plurality of simulation models in the integrated process can include setting the calculation order of functions of the plurality of simulation models and occurs based on the data transfer structure between the functions of the plurality of simulation models. Thus, the calculation order is broken down into smaller calculation units than whole simulation models, namely, into functions of the simulation models. An optimization of the calculation order with a greater granularity is thereby made possible.

The method can further comprise the following steps: assigning functions of the plurality of simulation models to simulation model-spanning tasks; and setting a calculation order of the simulation model-spanning tasks based on requirements of the functions assigned to the aforementioned simulation model-spanning tasks; and/or automatically setting the priorities of the simulation model-spanning tasks by assigning relative priorities. In this way, model parts originating from different simulation models can be combined for calculation in the integrated process. In particular, this enables a joint calculation of parts of the simulation models that interact with each other, whereas simulation model parts substantially independent from one another can be expanded for the calculation. Thus, the calculation can be directed more to the contextual relationships of parts of different simulation models than to the boundaries between the simulation models, as a result of which optimizations in terms of resource utilization and/or simulation quality can be achieved. The aforementioned functions can include interface functions described above as well as other functions present in the simulation models.

The assignment of the functions to the simulation model-spanning tasks and/or the automatic setting of the priorities of the simulation model-spanning tasks can occur based on user preferences and/or based on defined assignment routines. Thus, the assignment of functions to the simulation model-spanning tasks can occur fully automated but can also fully or partially implement user preferences. A flexible assignment of functions, but comprehensive in the absence of user preferences, to the simulation model-spanning tasks can be made possible.

The stated requirements for the functions and/or simulation model-spanning tasks can comprise execution time preferences and/or relative priorities in comparison with other functions and/or simulation model-spanning tasks. For example, the execution time preferences can specify that a given function is a function to be executed periodically as well as the step size in which the given function should be executed or calculated.

The method can further comprise the following step: setting a calculation order of the functions within the particular simulation model-spanning tasks based on the data transfer structure between the functions. In particular, the calculation order of the functions based on the data transfer structure can have any features, alone or in combination, that have been discussed above with respect to the calculation order of the simulation models. Thus, the effects achievable above with regard to the calculation order of the simulation models can also be achieved at the level of the functions and tasks of the simulation models.

Setting the calculation order as described herein, namely, setting the calculation order of the plurality of simulation models or simulation model functions, on the one hand, and setting the calculation order of the simulation model-spanning tasks, on the other, can be separate tasks, in particular without the process steps related to isolating, comparing, and modifying communication parameters and without the executability on a processor core. The setting of the calculation order, as described above, represents a possible alternative or modification of a calculation of simulation models in time slicing, i.e., a calculation of simulation models between predefined data transfer times between the simulation models. The aforementioned separate aspects are generally disclosed below. The features described above and dependent thereon are analogously applicable to this general disclosure.

Exemplary embodiments of the invention comprise further a method for providing an executable simulation for control unit development based on a plurality of simulation models, comprising at least one first simulation model and a second simulation model, wherein the executable simulation simulates a control unit or an environment of a control unit, in particular a technical system to be controlled, or a combination of a control unit and an environment of a control unit, in particular a combination of a control unit and a technical system to be controlled, and is executable on a simulation unit, comprising the step: setting a calculation order of the plurality of simulation models in the executable simulation based on the data transfer structure between the simulation models. The additional features, modifications, and effects, as described above for the method of providing an integrated process, are analogously applicable to the method of providing an executable simulation.

Exemplary embodiments of the invention further comprise a method for providing an executable simulation for control unit development based on a plurality of simulation models, comprising at least one first simulation model and a second simulation model, wherein the executable simulation simulates a control unit or an environment of a control unit, in particular a technical system to be controlled, or a combination of a control unit and an environment of a control unit, in particular a combination of a control unit and a technical system to be controlled, and is executable on a simulation unit, comprising the following steps: assigning functions of the plurality of simulation models to simulation model-spanning tasks; and setting a calculation order of the simulation model-spanning tasks based on requirements of the functions assigned to the aforementioned simulation model-spanning tasks. The additional features, modifications, and effects, as described above for the method of providing an integrated process, are analogously applicable to the method of providing an executable simulation.

Exemplary embodiments of the invention further comprise a simulation device for the control unit development, wherein the simulation device simulates a control unit or an environment of a control unit, in particular a technical system to be controlled, or a combination of a control unit and an environment of the control unit, in particular a combination of a control unit and a technical system to be controlled, said device comprising an integrated process which is based on a plurality of simulation models, wherein the plurality of simulation models comprises at least one first simulation model and a second simulation model, and which is executable on a single processor core of the simulation device; wherein the first simulation model has externally visible first communication parameters and the second simulation model has externally visible second communication parameters; and wherein identically named first and second communication parameters are modified at least for one of the first simulation models and the second simulation models for the integrated process. The additional features, modifications, and effects, as described above for the method of providing an integrated process, are analogously applicable to the simulation device mentioned.

It is also possible within the scope of the invention for a calculation order of a plurality of simulation models to be set based on the data transfer structure between the simulation models, independently of the provision of an integrated process, wherein setting a calculation order of the plurality of simulation models occurs based on a data transfer structure between the simulation models. Setting the calculation order of the plurality of simulation models can occur in this case based on at least one of the following factors: configuration of the particular data transfer links as a blocking data transfer link, in which the receiving simulation model is calculated when there are new input data, or as a non-blocking data transfer link, in which the receiving simulation model is calculated independently of the presence of new input data, and the presence of unilateral data transfer, bilateral data transfer, or no data dependency between respective pairs of simulation models or respective pairs of groups of simulation models. Setting the calculation order further can also include the step: combining simulation models into higher-level sorting units by forming subsets of simulation models communicating over blocking data transfer links, wherein the method in particular further comprises the following step: setting the calculation order of the higher-level sorting units based on the number of data transfer links that provide input data to the respective higher-level sorting units. Furthermore, setting the calculation order of the plurality of simulation models can include setting the calculation order of functions of the plurality of simulation models and can occur based on the data transfer structure between the functions of the plurality of simulation models.

It is also possible within the scope of the invention that an assignment of functions of the plurality of simulation models to simulation model-spanning tasks takes place independently of the provision of an integrated process and independently of the setting of the calculation order. In this case, the functions can be assigned to the simulation model-spanning tasks based on user preferences and/or based on defined assignment routines. The stated requirements of the functions can comprise execution time preferences and/or relative priorities in comparison with other functions. Furthermore, in this case, setting a calculation order of the functions within the particular simulation model-spanning tasks can occur based on the data transfer structure between the functions.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a simulation device with a control unit to be tested and connected thereto in a block diagram at the logic or model level, which can represent the starting point for a method for providing an integrated process according to an exemplary embodiment of the invention;

FIG. 2 shows the simulation device of FIG. 1 in an executable state after a method according to an exemplary embodiment of the invention has been carried out, wherein the simulation device of FIG. 2 also represents an exemplary embodiment of the invention;

FIG. 3 is a flowchart of a method for providing an integrated process according to an exemplary embodiment of the invention;

FIGS. 4A to 4D show an exemplary sequence for setting the calculation order of simulation models for an integrated process, wherein the sequence can be used in methods according to exemplary embodiments of the invention; and

FIGS. 5A to 5B shows an exemplary sequence for setting the calculation order of functions of simulation models for an integrated process, wherein the sequence can be used in methods according to exemplary embodiments of the invention.

### DETAILED DESCRIPTION

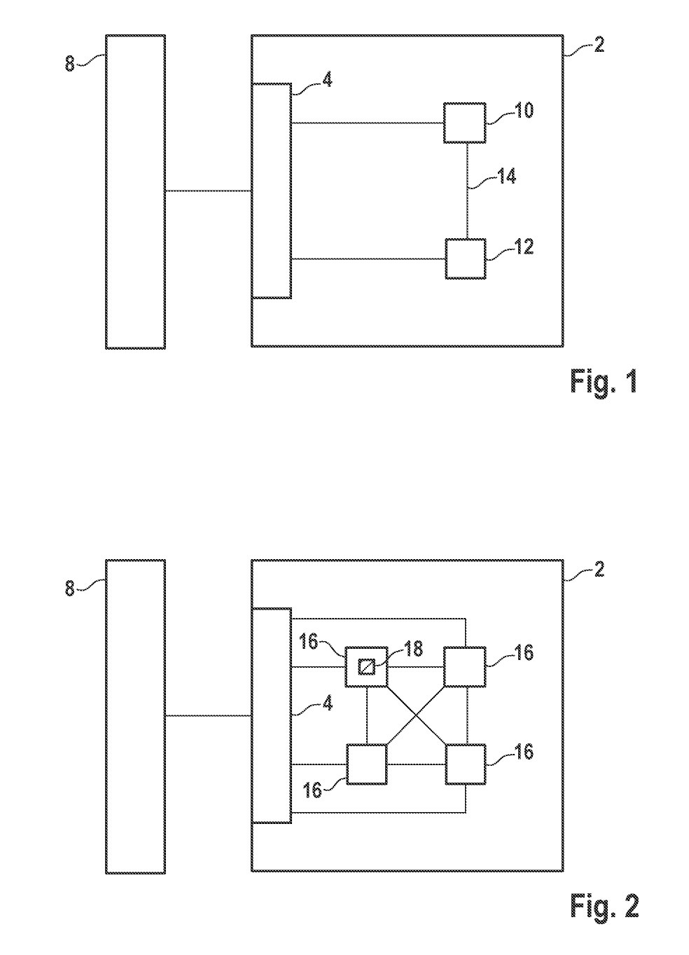

FIG. 1 shows a simulation device 2, which in the present case is an HIL simulator 2. HIL simulator 2 has a physical interface 4, via which external devices can be connected to HIL simulator 2. In FIG. 1, a control unit 8 is connected to physical interface 4. In the example of FIG. 1, control unit 8 is an engine control unit set up to control the engine of a motor vehicle. HIL simulator 2 is set up for testing engine control unit 8.

HIL simulator 2 includes a first simulation model 10 and a second simulation model 12. In the example of FIG. 1, first simulation model 10 is a model of the motor vehicle engine and second simulation model 12 is a model of the motor vehicle transmission. Both first simulation model 10 and second simulation model 12 are present as software models. First simulation model 10 and second simulation model 12 are high-level-language software models that are not directly executable on HIL simulator 2. In this respect, FIG. 1 shows HIL simulator 2 at a logic or model level, which does not yet reflect the state during the execution of a simulation. Consequently, the data transfer links shown between control unit 8 and first simulation model 10 and second simulation model 12 are implemented as still not executable via the physical interface but show at the model level the data transfer links that should exist when performing the simulation. The control unit can interact with the model of the engine, i.e., with the model of the technical system to be controlled, and with the model of the transmission by means of the data transfer links shown. Thus, the functionality as an engine control unit can be tested with the inclusion of the transmission as the engine environment.

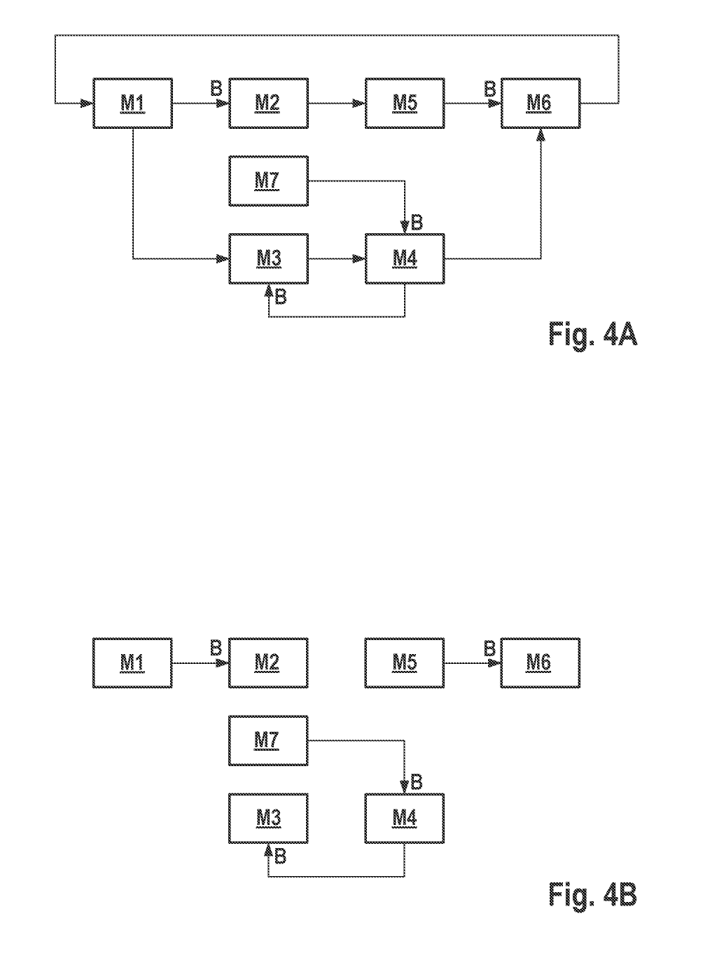

A data transfer link 14 is provided between first simulation model 10 and second simulation model 12. The method according to exemplary embodiments begins at the point where first simulation model 10 and second simulation model 12, together with their data transfer link 14 and the data transfer link in the direction of control unit 8, are converted into an executable process that can be executed on HIL simulator 12 for testing control unit 8. The steps of providing an executable process are described below with reference to FIG. 3.

In the example of FIG. 1, first simulation model 10 is a motor vehicle engine model developed for an HIL simulator. In contrast, second simulation model 12 is a motor vehicle transmission model, which has been used at an earlier stage of control unit development, for example, during a simulation with Simulink®. The models originating from different development environments or modeling environments are integrated into a single process for HIL simulator 2. In other words, the method described below can merge models from different development environments into an integrated process. It is also possible, however, that first simulation model 10 and second simulation model 12 originate from the same development environment or modeling environment.

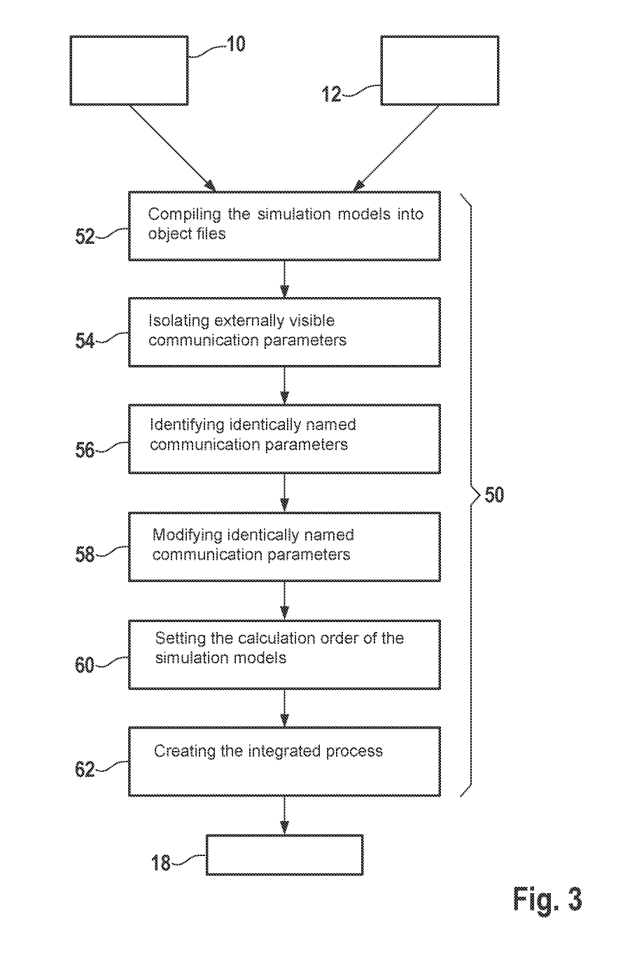

FIG. 2 shows HIL simulator 2 and control unit 8 to be tested and connected thereto at the stage of execution of the simulation, i.e., after carrying out the method described below. To better illustrate this state, FIG. 2 shows more details of the hardware structure of HIL simulator 2. In particular, FIG. 2 shows that HIL simulator 2 has four processor cores 16. The number of four processor cores is merely exemplary and can be lower or higher in other implementations. The four processor cores 16 are all connected to each other as well as to physical interface 4. As a result, in principle, all four processor cores 16 can cooperate in the control unit test and exchange data with one another. However, HIL simulator 2 contains only a single integrated process 18 by means of which first simulation model 10 and second simulation model 12 can be executed on HIL simulator 2. In particular, integrated process 18, which is provided based on first simulation model 10 and second simulation model 12, is executed only on one of the four processor cores 16. Only this one processor core is used for testing control unit 8 in regard to controlling the engine model and including the transmission model. Compared to previous approaches in which each simulation model has been executed on its own processor core, resources can be saved in this way. Also, the communication between the simulation models can be improved by execution on a single processor core. Integrated process 18 is a compiled, executable file and includes the functionality of first simulation model 10 and second simulation model 12 in executable form.

HIL simulator 2 is real-time-capable. Thus, control unit 8 can be tested without further adaptation, in other words, in its configuration used later in operation. HIL simulator 2 interacts with control unit 8 at the speed that a physically present technical system would have, in the present case, a combination of a real engine and real transmission of a motor vehicle. This in turn means that the behavior of integrated process 18 with the functionality of first simulation model 10 and second simulation model 12 is also calculated at at least this speed.

For the clearest possible illustration of an exemplary embodiment of the invention, only engine model 10 and transmission model 12 are shown in FIG. 1. Integrated process 18 of FIG. 2 is also based on these two models. However, it will be apparent to the skilled artisan that integrated process 18 can be provided based on more than two simulation models. In other words, integrated process 18 can provide the functionality of two or more simulation models in executable form.

It is possible that a method for providing integrated process 18 based on first simulation model 10 and second simulation model 12 runs on HIL simulator 2. However, it is also possible for first simulation model 10 and second simulation model 12 to be present in a different type of computer and also for the integrated process 18 to be created there. It can be imported as an executable file into HIL simulator 2.

It is emphasized that HIL simulator 2 in FIGS. 1 and 2 is merely an exemplary simulation device. It is possible, for example, for a method for providing an integrated process according to exemplary embodiments of the invention to provide an integrated process for an RCP simulation device. In this case, the first simulation model and the second simulation model can be, for example, a first submodel of a control unit and a second submodel of a control unit or a model of a control unit and a model of a technical system in the environment of the control unit.

FIG. 3 is a flowchart of a method 50 for providing an integrated process for control unit development according to an exemplary embodiment of the invention. Method 50 has as a starting point a first simulation model 10 and a second simulation model 12 and supplies as an end product an integrated process 18 that can be executed on a simulation device. In analogy to FIGS. 1 and 2, these entities are shown in FIG. 3 as input and output variables.

In step 52, first simulation model 10 and second simulation model 12 are compiled into a first object file and a second object file. In this way, first simulation model 10 and second simulation model 12, which can originate from different development environments, are brought into a uniform format. Thus, the further processing can be facilitated. The first object file and second object file are then combined to form a common object, which forms the basis for further processing.

In step 54, it is determined which communication parameters of the first and second simulation model, i.e., the first and the second object file, are externally visible, i.e., used from outside the particular simulation model, e.g., addressed or read. The communication parameters can be, for example, the calls of interface functions of the particular simulation models or variables relevant outside the particular simulation models. The externally visible communication parameters can be, for example, communication parameters relevant to other simulation models within the simulation and/or communication parameters relevant to the user for controlling or checking the test. The setting of the externally visible communication parameters is also referred to herein as isolating externally visible communication parameters. The externally visible communication parameters of the first simulation model are also referred to as first communication parameters and the externally visible communication parameters of the second simulation model are also referred to as second communication parameters.

In step 56, identically named communication parameters in the first and second simulation models are identified by comparing the first communication parameters and the second communication parameters. In other words, it is determined whether there are identical names for externally visible communication parameters, e.g., for externally visible interface functions or variables, between the first simulation model and second simulation model.

In step 58, the names of the identically named communication parameters are modified. In this way, a unique address space is created within the common object from the first simulation model and second simulation model. Each communication parameter can then be uniquely assigned. When the identically named communication parameters are modified, a wrapper function is applied to the identically named communication parameters. In this case, the original name of the particular communication parameter is retained for the modified name and supplemented by an extension that makes the modified name unique.

The modification of identically named communication parameters is described with a specific example. It is possible that both the engine model and the transmission model have the function call GetSpeedEngine. In the transmission model, this can mean the speed of a shaft on the engine side. Regardless of the speed of which component the two models address with the function mentioned, both models have an identical externally visible interface function. In step 58, this function call for the engine model object can be changed to Engine_GetSpeedEngine and for the transmission model object modified to Transmission_GetSpeedEngine. In the common object there are then two unique function calls for the previously identically named interface functions.

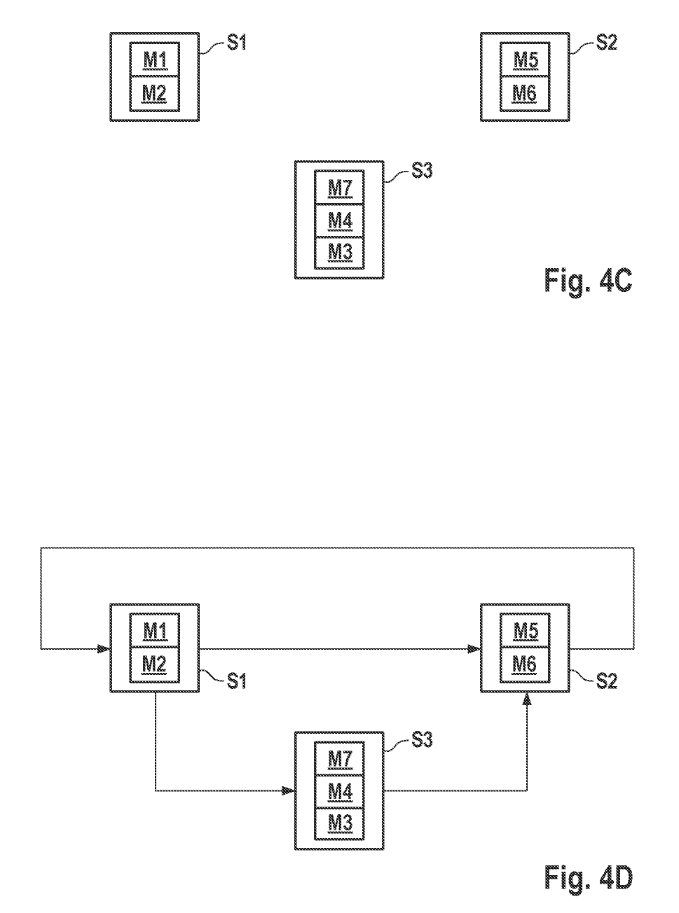

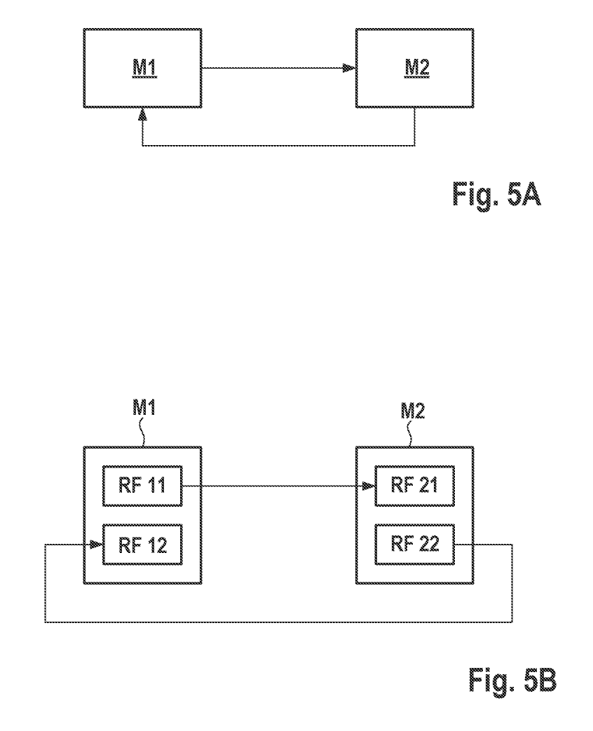

In step 60, the calculation order of the simulation models for execution in the integrated process is set. In this case, the simulation models as a whole can be brought into a calculation order or subunits of the simulation models, e.g., functions of the simulation models, serve as the basis for setting the calculation order. In the latter case, the subunits of the simulation models can be mixed with respect to the calculation order. Exemplary settings of the calculation order will be described below with reference to FIGS. 4 and 5.

In step 62, integrated process 18 is created. In particular, an executable file is created which takes into account the names of the communication parameters modified in step 58 and the calculation order set in step 60. Step 62 can also be viewed as compiling the common object of the first and second simulation models, taking into account the determinations made during method 50. The integrated process 18 is the product of step 62.

FIG. 4 illustrates an example of setting the calculation order of a plurality of simulation models as they can be used in methods of providing an integrated process in control unit development in accordance with exemplary embodiments of the invention. For example, the features of setting the calculation order, as illustrated with reference to FIG. 4, can be used in step 60 of the method of FIG. 3. In FIG. 4, the setting of the calculation order is illustrated using an example with seven simulation models, all of which are to be integrated into one executable process. Such an example with more than two simulation models illustrates different features of setting the calculation order in a greater generality than an example with two simulation models.

FIG. 4A shows an example of a plurality of simulation models, on the basis of which an integrated process for execution on a simulation device is to be provided, as well as their data transfer links. In particular, FIG. 4A shows a first simulation model M1, a second simulation model M2, a third simulation model M3, a fourth simulation model M4, a fifth simulation model M5, a sixth simulation model M6, and a seventh simulation model M7.

Between the seven simulation models M1-M7, there is provided a series of data transfer links, indicated by arrows, which are in part blocking data transfer links, provided with a B, and in part non-blocking data transfer links. A blocking data transfer link is provided from first simulation model M1 to second simulation model M2. A non-blocking data transfer link is provided from first simulation model M1 to third simulation model M3. A non-blocking data transfer link is provided from second simulation model M2 to fifth simulation model M5. A non-blocking data transfer link is provided from third simulation model M3 to fourth simulation model M4. A blocking data transfer link is provided from fourth simulation model M4 to third simulation model M3. A non-blocking data transfer link is provided from fourth simulation model M4 to sixth simulation model M6. A blocking data transfer link is provided from fifth simulation model M5 to sixth simulation model M6. A non-blocking data transfer link is provided from sixth simulation model M6 to first simulation model M1. A blocking data transfer link is provided from seventh simulation model M7 to fourth simulation model M4. The totality of the data transfer links is referred to as the data transfer structure.

Before the setting of the calculation order is described in greater detail with reference to several steps shown in FIGS. 4B to 4D, two factors considered in setting the calculation order will be described.

A first factor is the configuration of the particular data transfer links as a blocking data transfer link, in which the receiving simulation model is calculated if there are new input data, or as a non-blocking data transfer link, in which the receiving simulation model is calculated independently of the presence of new input data. In a blocking data transfer link, the sender function of a sending simulation model consistently provides all data of a communication packet, and the receiver function of a receiving simulation model reads out the data of the communication packet only when there is new data compared with the last access. Otherwise, the receiver function waits until new data are available. In a non-blocking data transfer link, the sending function of a sending simulation model consistently provides all data of a communication packet, and the receiving function of a receiving simulation model together reads out the data of the communication packet, regardless of whether new data are available or not. It can be set by configuration as a blocking or non-blocking data transfer link whether the receiver function is executed at regular intervals or event-driven. This configuration can be made by the user or automated using a script or some other suitable way. In setting the calculation order, priority can be given to the sending simulation model in the case of two models that are directly connected to each other and whose data transfer link is configured as blocking. The event-driven linking of these simulation models is supported in this way.

A second factor is the presence of unilateral data transfer, bilateral data transfer, or no data dependency between respective pairs of simulation models or respective pairs of groups of simulation models. A simulation model N is the clear successor to a simulation model V if V directly or indirectly supplies data to N, but N supplies data to V neither directly nor indirectly. In such a case, this is also referred to as unilateral data transfer from V to N. Two simulation models K1 and K2 have a data dependency in a circle if they supply each other with data directly or indirectly, therefore, if K2 is reached in the data flow direction starting from K1 and further K1 is again reached in the data flow direction. In such a case, this is also referred to as bilateral data transfer between K1 and K2. Two simulation models have no data dependency if they do not supply data either directly or indirectly. The categorization between unilateral data transfer, bilateral data transfer, and no data dependency of simulation models or groups of simulation models can be used to optimize the calculation order of the simulation models in terms of simulation quality and/or resource requirements, as explained below.

One possible method for setting the calculation order of the simulation models shown in FIG. 4A will now be described with reference to FIGS. 4B to 4D.

FIG. 4B illustrates a first step of setting the calculation order of the simulation models. In particular, this first step is to consider only the blocking data transfer links. Therefore, FIG. 4B only shows the blocking data transfer links, labeled with B, between first simulation model M1 and second simulation model M2, between fifth simulation model M5 and sixth simulation model M6, and between seventh simulation model M7 and fourth simulation model M4 and third simulation model M3. The initial focus on the blocking data transfer links arises from the observation stated above that it is particularly advantageous in the case of blocking links to set the calculation order in line with the data flow.

FIG. 4C illustrates a second step of setting the calculation order of the simulation models. Based on the blocking data transfer links shown in FIG. 4B, the simulation models that communicate either directly or indirectly with each other via blocking data transfer links are in each case combined to form higher-order sorting units. In the present example, first simulation model M1 and second simulation model S2 are combined into a first higher-order sorting unit S1, fifth simulation model M5 and sixth simulation model M6 are combined into a second higher-order sorting unit S2, and third simulation model M3 and fourth simulation model M4 and seventh simulation model M7 are combined into a third higher-order sorting unit S3.

Furthermore, in the second step illustrated in FIG. 4C, the simulation models are arranged according to their data flow in the higher-order sorting units; i.e., the calculation order of the simulation models in the higher-order sorting units is set based on the data flow directions. In the first higher-order sorting unit S1, the calculation order is M1, M2. In the second higher-order sorting unit S2, the calculation order is M5, M6. In the third higher-order sorting unit S3, the calculation order is M7, M4, M3.

In the present example, the data flow directions in the higher-order sorting units are unique. Accordingly, the calculation order can be set immediately according to the data flow directions. If there are data dependencies in the higher-order sorting units in a circle, these can be broken by user interaction or randomly or by another suitable algorithm, so that in these cases as well, a calculation order can be set automatically.

FIG. 4D illustrates a third step of setting the calculation order of the simulation models. The non-blocking data transfer links between the higher-level sorting units S1, S2, and S3 are considered again. These are taken from FIG. 4A and redrawn in FIG. 4D.

The higher-order sorting units are sorted based on the number of incoming data transfer links. In particular, the higher-level sorting units that have a smaller number of incoming data transfer links are placed further ahead in the calculation order. In the present example, the first and third higher-level sorting units S1, S3 each have an incoming data transfer link, whereas the second higher-order sorting unit S2 has two incoming data transfer links. Of the two higher-level sorting units with an incoming data transfer link, the first higher-level sorting unit is randomly placed further ahead in the calculation order. This results in the calculation order S1, S3, S2 for the higher-order sorting units. For the simulation models, this results in the calculation order M1, M2, M7, M4, M3, M5, M6.

It has been shown that calculation orders of simulation models set in this way lead to high-quality simulation results because the calculation order harmonizes well with the structure of the data transfer structure. In addition, a relatively low requirement for resources, e.g., the required computing time, has been set.

FIG. 5 illustrates a further example of setting the calculation order of a plurality of simulation models as they can be used in methods of providing an integrated process in control unit development in accordance with exemplary embodiments of the invention. For example, the features of setting the calculation order, as illustrated with reference to FIG. 5, can be used in step 60 of the method of FIG. 3. In the example of FIG. 5, the simulation models are not placed in a specific order as a whole, but the functions of the simulation models are used as the sorting basis. To limit the complexity of the description, only two simulation models are considered in the example of FIG. 5.

FIG. 5A shows an example of a plurality of simulation models, on the basis of which an integrated process for execution on a simulation device is to be provided, as well as their data transfer links. In particular, FIG. 5A shows a first simulation model M1 and a second simulation model M2. Two non-blocking data transfer links are provided, one in each direction, between first simulation model M1 and second simulation model M2.

FIG. 5B shows the internal structure of simulation models M1, M2. The first simulation model has a first function RF11 and a second function RF12. The second simulation model has a third function RF21 and a fourth function RF22. The data transfer link from first simulation model M1 to second simulation model M2 runs from first function RF11 to third function RF21. First function RF11 and third function RF21 form a first task. The data transfer link from second simulation model M2 to first simulation model M1 runs from fourth function RF22 to second function RF12. Second function RF12 and fourth function RF22 form a second task.

According to the above considerations for the calculation order in unilateral data transfers, it is established that first function RF11 is calculated before third function RF21 and fourth function RF22 before third function RF12. The total calculation order is set as RF11, RF21, RF22, RF12 or RF22, RF12, RF11, RF21. The choice between these two options can be made by random decision.

By setting the calculation order described with reference to FIG. 5, the integrated process can be optimized more granularly than with the setting according to the principle described with reference to FIG. 4. The setting according to FIG. 5 can be regarded as a refinement of the setting according to FIG. 4.

An expansion of the setting of the calculation order according to FIG. 5 will be described below. In particular, this expansion enables the consideration of functions without existing task assignment and of execution time requirements.

The starting point of the expansion is a plurality of simulation models that are to be converted into an integrated process executable on a single processor core of a simulation device. The simulation models have functions. A first part of the functions is assigned to predefined tasks, whereas a second part of the functions has no task assignment. These functions are also called free functions. At least some of the functions have execution time preferences. In particular, these functions can include the requirement that they are each to be calculated at periodic intervals with a predetermined step size. This type of preference is also called a cycle time restriction.

A calculation order of the functions can be set as follows. The functions of the predefined tasks are analyzed with regard to the execution time preferences. Functions with different execution time preferences are separated and assigned to new tasks with suitable execution time preferences. Functions of different predefined tasks but the same execution time preferences are combined into common new tasks. Free functions that have execution time preferences that conform to other tasks are assigned to these other tasks. For free functions that have execution time preferences that do not conform to any other tasks, new tasks are created with suitable execution time preferences. For free functions that do not have execution time preferences, new tasks are created without execution time preferences. Thus, all functions are assigned to corresponding tasks according to their execution time preferences.

The calculation order of the functions is set based on the assignment to tasks using relative priorities as follows. The functions of tasks with smaller step sizes, i.e., shorter periodic execution time requirements, are given a higher priority than the functions of tasks with larger step sizes. Within a task, i.e., within a group of functions with the same execution time requirements, relative priorities are set according to the calculation order as described above with reference to FIG. 5. In this way, the calculation order regarding execution time requirements and data flow between the functions of the plurality of simulation models can be optimized. The relative priorities can be converted into a corresponding calculation order with little complexity.

The priorities of the simulation model-spanning tasks are automatically set as follows based on relative priorities. The tasks with smaller step sizes, i.e., with shorter periodic execution time requirements, are given a higher priority than the tasks with larger step sizes. Within a group of tasks with the same execution time requirements, relative priorities are set according to the calculation order as described above with reference to FIG. 5. In this way, it is possible to optimize the calculation order regarding execution time requirements and the data flow between the functions of the plurality of simulation models. A first task can interrupt the execution of a second task during the execution if the priority of the first task is higher than the priority of the second task.

Exemplary embodiments of the invention, as described herein, enable, inter alia, the integration of multiple simulation models from different modeling environments into one executable process, the integration of simulation models, originating from different versions of the same modeling environment, into one executable process, and the integration of simulation models with different calculation step sizes into one process. In addition, calculation orders, optimized with regard to resource requirements and/or simulation quality, of the simulation models and/or functions of the simulation models in the integrated process are possible.

Although the invention has been described with reference to exemplary embodiments, it will be apparent to a skilled artisan that various changes can be made and equivalents can be employed without departing from the scope of the invention. The invention should not be limited by the specific embodiments described. Rather, it includes all embodiments that fall under the appended claims.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for developing a control unit based on a plurality of simulation models comprising at least one first simulation model and a second simulation model, wherein the integrated process simulates a control unit or an environment of a control unit or a technical system to be controlled or a combination thereof, the method being executable on a simulation device, the method comprising:
isolating externally visible first communication parameters of the first simulation model and isolating externally visible second communication parameters of the second simulation model;
comparing the first communication parameters and the second communication parameters and identifying identically named communication parameters; and
modifying the identically named communication parameters at least for one of the first simulation models and the second simulation models such that the integrated process is executable on a single processor core.

2. The method according to claim 1, wherein the first communication parameters and the second communication parameters comprise variable names and/or calls for interface functions.

3. The method according to claim 1, wherein modifying the identically named communication parameters comprises applying a wrapper function to the identically named communication parameters.

4. The method according to claim 1, further comprising the steps of:
compiling the first simulation model into a first object file;
compiling the second simulation model into a second object file; and
merging the first object file and the second object file into a common object file.

5. The method according to claim 1, wherein the first simulation model and the second simulation model originate from different modeling environments.

6. The method according to claim 1, wherein the integrated process is provided in the form of a single executable file.

7. The method according to claim 1, further comprising the step of:
setting a calculation order of the plurality of simulation models in the integrated process based on a data transfer structure between the simulation models.

8. The method according to claim 7, wherein setting the calculation order of the plurality of simulation models is based on:
a configuration of the particular data transfer link as a blocking data transfer link, in which the receiving simulation model is calculated if there are new input data, or as a non-blocking data transfer link, in which the receiving simulation model is calculated independently of the presence of new input data; or
a presence of unilateral data transfer, bilateral data transfer, or no data dependency between respective pairs of simulation models or respective pairs of groups of simulation models.

9. The method according to claim 7, further comprising the step of:
combining simulation models into higher-level sorting units by forming subsets of simulation models communicating over blocking data transfer links; and
setting the calculation order of the higher-level sorting units based on the number of data transfer links that provide input data to the respective higher-level sorting units.

10. The method according to claim 7, wherein setting the calculation order of the plurality of simulation models in the integrated process includes setting the calculation order of functions of the plurality of simulation models and occurs based on the data transfer structure between the functions of the plurality of simulation models.

11. The method according to claim 1, further comprising the steps of:
assigning functions of the plurality of simulation models to simulation model-spanning tasks; and
setting a calculation order of the simulation model-spanning tasks based on requirements of the functions assigned to the aforementioned simulation model-spanning tasks by an automatic setting of priorities of the simulation model-spanning tasks.

12. The method according to claim 11, wherein the assignment of the functions to the simulation model-spanning tasks and/or the automatic setting of the priorities of the simulation model-spanning tasks occur based on user preferences and/or based on defined assignment routines.

13. The method according to claim 11, wherein the stated requirements for the functions and/or simulation model-spanning tasks comprise execution time preferences and/or relative priorities in comparison with other functions and/or simulation model-spanning tasks.

14. The method according to claim 11, further comprising the step of:
setting a calculation order of the functions within the particular simulation model-spanning tasks based on the data transfer structure between the functions.

15. A simulation device for control unit development, wherein the simulation device simulates a control unit or an environment of a control unit or a technical system to be controlled, or a combination thereof, the device comprising:
an integrated process based on a plurality of simulation models, the plurality of simulation models comprising at least one first simulation model and a second simulation model and is executable on a single processor core of the simulation device;
wherein the first simulation model has externally visible first communication parameters and the second simulation model has externally visible second communication parameters, and
wherein identically named first and second communication parameters are modified at least for one of the first simulation models and the second simulation models for the integrated process.
